(19) United States
(12) Patent Application Publication
(10) Pub. No.: US 2025/0323694 A1
(43) Pub. Date: Oct. 16, 2025

(54) DISTRIBUTED UNIT MONITORING AND CORRECTION OF A RADIO UNIT'S TRANSMITTER-RECEIVER CALIBRATION

(71) Applicant: Dell Products L.P., Round Rock, TX (US)

(72) Inventors: Eran Goldstein, Montreal (CA); Mohammed Abdelsadek, Kanata (CA); Jayaram Venguduswamy Srinivasan, Nepean (CA)

(21) Appl. No.: 18/637,179

(22) Filed: Apr. 16, 2024

(51) Int. Cl. H04B 7/0456

(52) U.S. Cl. CPC H04B 7/0479

(57) ABSTRACT

The technology described herein is directed towards monitoring transmitter and receiver phase calibration by measuring phase calibration inaccuracies in a deployed and running base station, without utilizing any additional hardware or additional signaling. A group of reported user equipment precoding matrix indicators (PMIs) corresponding to each antenna of a radio unit of the base station is obtained and combined (e.g., averaged) into a user equipment-based PMI. A sounding reference signal (SRS)-based PMI is estimated at the base station based on user equipment sounding reference signal data received via the antenna. Receive and transmit phase difference data is determined for each antenna based on its corresponding user equipment-based PMI and the SRS-based PMI. Action can be taken on the phase difference, including to determine phase difference calibration coefficient data that is applied to compensate for the receive and transmit phase difference data, and/or report the difference data to an operator.

### BACKGROUND

In wireless radio communications, beamforming and/or precoding of the downlink (DL) channels from a base-station to a user equipment (UE) can rely on channel state information (CSI). In this case, the UE reports back the desired precoding scheme from a few options given by the Third Generation Partnership Project (3GPP) standard in a “codebook.” Because the general goal of the codebook is to reduce the amount of control signaling, the number of codebook options is limited. As a result, the selected precoding matrices are often suboptimal.

### BRIEF DESCRIPTION OF THE DRAWINGS

The technology described herein is illustrated by way of example and not limited in the accompanying figures in which like reference numerals indicate similar elements and in which:

FIG. 1 is a block diagram representation of an example system in an open-radio access network (O-RAN) architecture in which a distributed unit includes transmitter-receiver (Tx-Rx) calibration monitoring and correction logic with respect to the Tx-Rx antenna pairs of a radio unit, in accordance with various implementations and embodiments of the subject disclosure.

FIG. 2 is a flow diagram showing example operations related to measuring/calculating Tx-Rx antenna pair calibration misalignment, and estimating phase calibration error data based on the misalignment, in accordance with various implementations and embodiments of the subject disclosure.

FIG. 3 is a block diagram representation of an example group of different user equipment (UEs) sending respective channel state information (CSI) reports at different times that are used for determining UE-based precoding matrix indicators (PMIs) that are further used determine phase difference data per antenna, in accordance with various implementations and embodiments of the subject disclosure.

FIGS. 4 and 5 comprise a flow diagram showing example operations related to logic that determines a calibration coefficient for a Tx-Rx antenna pair, in accordance with various implementations and embodiments of the subject disclosure.

FIG. 6 is an example illustrating numerically that quantization in selecting a PMI from a codebook has a minor impact on the estimated phase after combining PMIs from different CSI reports, in accordance with various implementations and embodiments of the subject disclosure.

FIG. 7 is a flow diagram showing example operations related to determining receive and transmit phase difference data for an antenna based on a user equipment-based precoding matrix indicator and an estimated sounding reference signal-based precoding matrix indicator, in accordance with various implementations and embodiments of the subject disclosure.

FIG. 8 is a flow diagram showing example operations related to determining respective receive and transmit phase difference data for respective antennas based on respective user equipment-based precoding matrix indicators and respective estimated sounding reference signal-based precoding matrix indicators, in accordance with various implementations and embodiments of the subject disclosure.

FIG. 9 is a flow diagram showing example operations related to estimating respective calibration coefficients for respective transmit-receive phases for respective antennas based on respective user equipment-based precoding matrix indicators and respective estimated sounding reference signal-based precoding matrix indicators, in accordance with various implementations and embodiments of the subject disclosure.

FIG. 10 is a block diagram representing an example computing environment into which the subject matter described herein may be incorporated and/or may communicate.

FIG. 11 depicts an example schematic block diagram of a computing environment with which the disclosed subject matter can interact/be implemented at least in part, in accordance with various implementations and embodiments of the subject disclosure.

### DETAILED DESCRIPTION

Various implementations and embodiments of the technology described herein are generally directed towards measuring phase calibration inaccuracies in a deployed and running base station, without utilizing any additional hardware or external or internal measurements. Additionally, described herein is a technique to address those inaccuracies in software, without the need for recalibrating the base station's radio unit.

In time division duplexing (TDD) scenarios, the property of channel reciprocity can be exploited in which the same radio resources (frequency/channel) are used in uplink and downlink communications. Channel reciprocity significantly improves the selection of the downlink precoding matrix selected, based on the transmitter (Tx) and receiver (Rx) being phase calibrated. In this regard, if Tx-Rx phase calibration is accurate, the base station can use the uplink sounding reference signal (SRS) transmitted by a user equipment (UE) to calculate the optimal precoding matrix, as anything measured in the uplink direction is assumed to be the same in the downlink direction, and vice-versa. However, various factors can adversely impact the initial calibration of the radio unit (i.e., any of the whole system including the antennas). Such factors can include, but are not limited to, heating, aging, mechanical damage, and humidity. These factors can impact the power in the different Tx-Rx components, including the antenna, cables, connectors, and power amplifier. In addition, a soft degradation in the radio unit's antenna side can degrade the previous calibration, and therefore degrade the entire system performance (e.g., scheduling, beamforming, precoding and so on) as a consequence of selecting suboptimal downlink precoding/beamforming matrices. Although some soft degradation that occurs at the radio unit side possibly can be discovered by some indirect statistical data collected by the network, this takes significant effort and time, and may be hidden, as the information is not direct.

In general, achieving Tx-Rx phase calibration is a demanding process; in open radio access networks (O-RAN), where several manufacturers exist and interact, a trust between different vendors based on multiple levels of testing is employed. Note that even though some radio units have self-test mechanisms, self-testing may not detect issues associated with the antenna or the antenna connections. Moreover, not all deployed radio units support internal calibration, whereby such radio units can benefit from run time based calibration as described herein.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization,” “optimize” or “optimal” and the like (e.g., “maximize,” “minimize” and so on) only represent objectives to move towards a more optimal state, rather than necessarily obtaining ideal results.

The subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

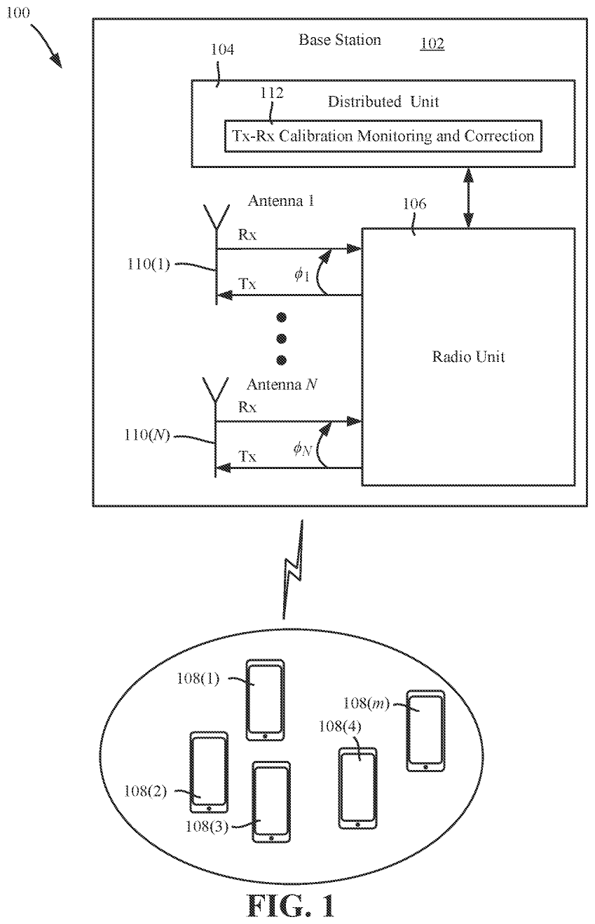

FIG. 1 shows an example system/architecture 100, in which in this example open radio access network (O-RAN) implementation, a base station 102 includes or is coupled to a distributed unit 104 and a radio unit 106. The distributed unit 104 may be coupled to more than one radio unit (not explicitly shown in FIG. 1).

As represented in FIG. 1 and in general, the radio unit 106 communicates wirelessly with one or more user equipment devices (UEs) 108(1)-108(m). In a multiple antenna system, e.g., a multiple input and multiple output (MIMO) system, the radio unit 106 communicates through multiple antennas 110(1)-110(N).

Initially, a radio unit such as the radio unit 106 is calibrated with respect to the transmitter (Tx) and receiver (Rx) operations for each of the antennas 110(1)-110(N). Indeed, conventional distributed units assume the radio unit's Tx-Rx pairs are correctly calibrated, including for adjusting scheduling, beamforming, precoding, and so on. However, if this assumption is not true, some performance degradation results from inaccurate scheduling, beamforming, precoding, and so on.

In unpaired spectrum systems like time division duplexing (TDD) networks, reciprocity can be assumed, that is, the channel is the same for the uplink and downlink. However, a phase difference between a given Tx and Rx antenna previously has been expected and assumed, due to various reasons. In this regard, a single global phase, which does not change with the frequency, time, or antenna index, does not impact the received or transmitted signals. However, any other phase difference between the Tx and Rx antenna pairs can be significant.

As shown in FIG. 1, over time due to degradation as described herein, a calibrated Tx-Rx pair can become misaligned, such that there may be a phase difference ϕ1, ϕ2, . . . , ϕ_{N} for one or more of the antennas 110(1)-110(N), respectively. In such scenarios, the assumption by a conventional distributed unit is incorrect, resulting in a degradation in performance.

The distributed unit 104, based on the technology described herein, incorporates (or is coupled to) Tx-Rx calibration monitoring and correction logic 112 that monitors for misaligned Tx-Rx calibrations, per antenna, and takes some corrective action when detected. As described herein, various actions include, but are not limited to, reporting the errors to the operator of the base station 102, correcting the errors (e.g., in software in the Tx-Rx calibration monitoring and correction logic 112 of the distributed unit 104) by applying a calibration phasor over the SRS-based precoding matrix to correct the transmission (without any additional signaling and/or modification to the 3GPP standards), and/or collecting and periodically reporting the raw measured data to the operator. A threshold phase difference error level may be used (e.g., set by the operator) to exclude taking action(s) for errors deemed trivial.

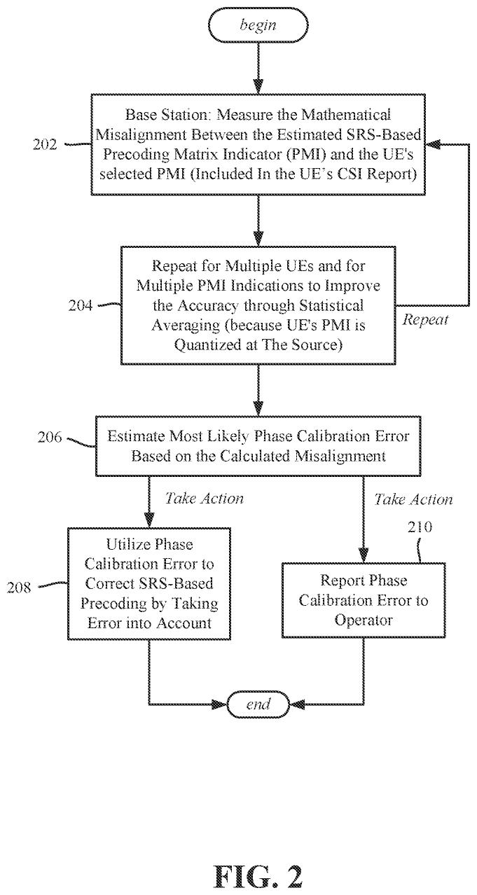

Example main operations for the monitoring and correction action(s) are summarized in FIG. 2. Operation 202 represents the base station measuring the mathematical misalignment between the estimated SRS-based precoding matrix indicator (PMI) and the UE's selected PMI (which is included in the CSI report). As represented via block 204, because the UE's PMI is quantized at the source, operation 202 has to be performed for multiple UEs' PMIs and/or for multiple PMI indications (e.g., of one UE or multiple UEs) for the purpose of improving the accuracy through statistical combining, such as by averaging or using a similar mathematical combining, e.g., taking the median, averaging after removing outliers, and so forth. At operation 206, a most likely phase calibration error is estimated based on the calculated misalignment.

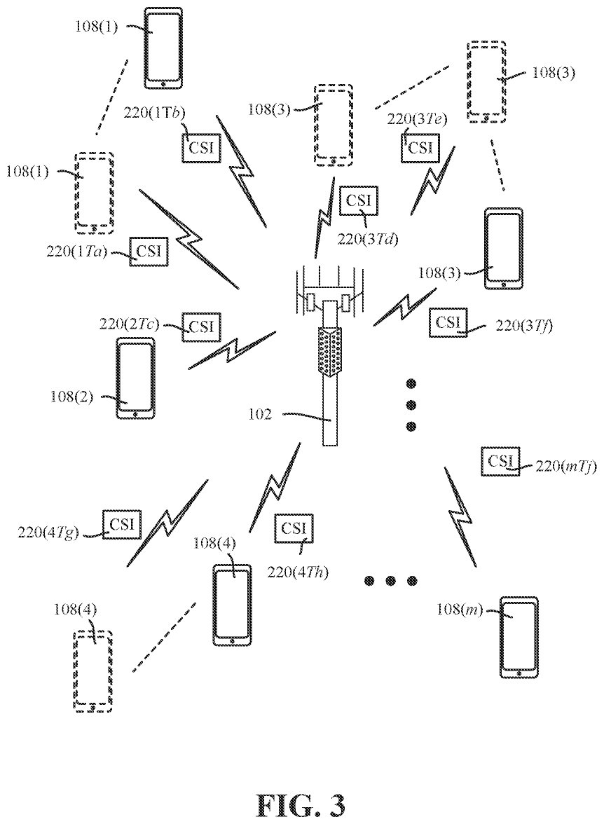

As shown in FIG. 3, the base station 102 thus collects channel state information (CSI) reports from many different UEs, e.g., 108(1)-108(m), and/or at different times Ta-Tj, each typically coming from different directions and angles. In FIG. 3, these CSI reports are labeled by the corresponding UE number and the time reported, e.g., CSI report 220(1Ta) is reported by the UE 108(1) at time Ta, CSI report 220(1Tb) is reported by the same UE 108(1) at a different time Tb, the CSI report 220(2Tc) is reported by another UE 108(2) at a different time Tc, and so on. In the example of FIG. 3, each UE represented with dashed lines is at a prior location relative to a later location as represented as a UE with solid lines.

Returning to FIG. 2, following the example operation 206 in which the phase calibration error was estimated, some appropriate action is then taken, such as including, but not limited to, using the phase calibration error to correct the SRS-based precoding by taking into account the error via operation 208, e.g., at the distributed unit 104. Instead of, or in addition to correcting the SRS-based precoding, the detected calibration error can be reported to the operator (operation 210) and/or used locally to reduce the impact (e.g., via operation 208) until a fix is provided, for example, by sending a technician to examine and repair or replace the radio unit/antenna/other component(s). Note further that the network can benefit from such additional metric/error data, such as to use for predictive modeling related to failures, if, for example, the soft failure rate accelerates uncharacteristically. Still further, the technology described herein can be used in the manufacturing stage for testing and validating radio units/base stations.

Consider that the calibration error between the Tx and Rx paths of each antenna can be represented (modeled) by equation (1):

$${H}_{T , i , n} = {C}_{i} {H}_{R , i , n} , \qquad ( 1 )$$

where Cᵢ is the calibration coefficient (which is unknown), H_{T,in} is the transmitter channel gain, including the internal transmission gain and the phase difference compared to the receiver one, H_{R,i,n} is the receiver channel gain, i=1, 2, . . . , N_{T} is the index of the Tx/RX, where N_{T} is the number of antennas (Rx or Tx), and n=1, 2, . . . , N_{CSI} is the number of CSI reports from the selected UEs (possibly all UEs) in a given calibration time frame. It should be noted that a given UE can provide more than one CSI report in the given time frame, and that there may be only one UE sending the multiple CSI reports that are used.

Calculating the calibration coefficient can be formulated as an optimization problem as in equation (2):

$${C}_{i}^{*} = arg min {\sum }_{n = 1}^{{N}_{CSI}} {‖ {P\_CSI}_{i , n} - {P\_SRS}_{i , n} ‖}^{2} , \qquad ( 2 )$$

where Cᵢ* is the optimal calibration coefficient for which the error is minimized, P_CSI_{i,n} is the precoding coefficient for the ith antenna requested by the UE/CSI report n, and P_SRS_{i,n} is the optimal precoding matrix found by the base station at the request time, using the same rank as selected by the UE (assuming reciprocity up to a given calibration coefficient Ct). Note that the base station receives the rank indicator (RI) and PMI information from the UE in the CSI report. Using the same rank indicator as indicated by the UE, the base station calculates the PMI to be used.

The optimization problem in equation (2) can be solved in multiple ways, including artificial intelligence/machine learning, the Newton method or the genetic algorithm. However, because these optimizations have high computational complexity, which may not be appropriate for processing at the base station level, described herein is a heuristic procedure to solve the optimization problem in a relatively low complexity manner.

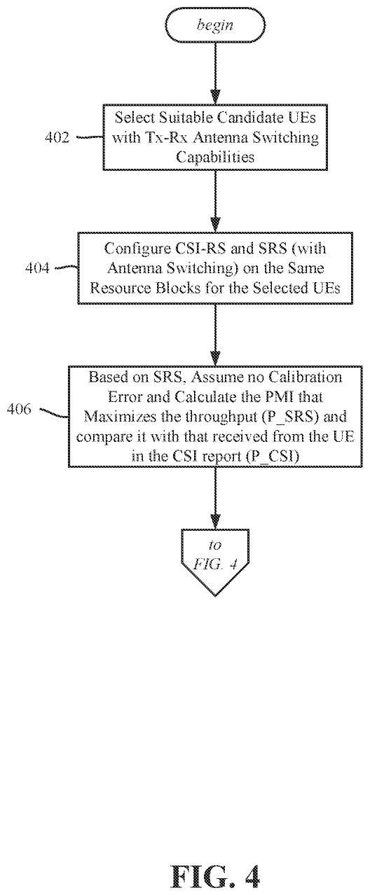

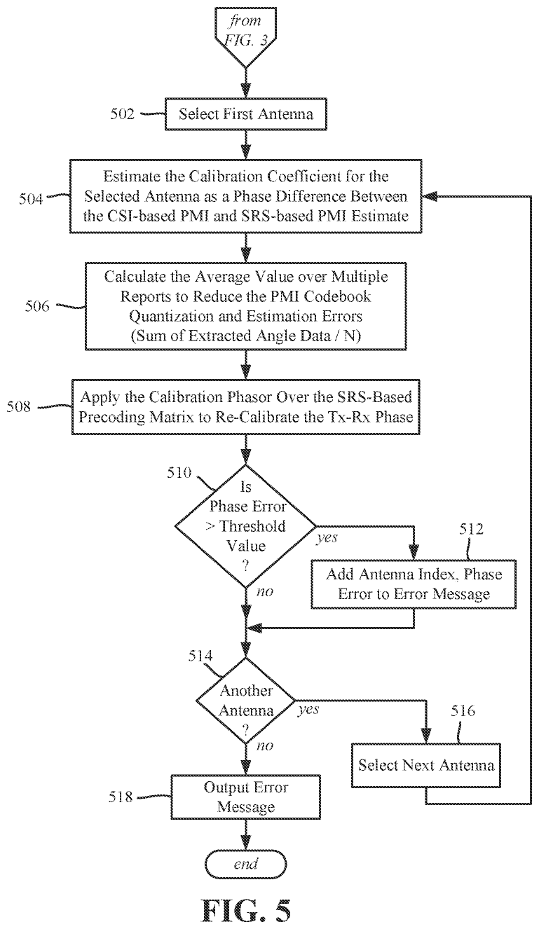

FIGS. 4 and 5 describe one example procedure, beginning at operation 402 of FIG. 4, which selects suitable candidate UEs with Tx-Rx antenna switching capabilities. With respect to antenna switching, the logic, if there is a sufficient number of UEs from which to choose, can give higher priority to (or assign more weight to) UEs that can be configured to send SRS signals from all of their antennas; i.e. each of the UEs Rx antennas can also be used individually in Tx to send a unique SRS (or other UL channel) signal. Note however that the logic can work with UEs having less Tx antennas than Rx antennas (e.g., four antennas are used for Rx, but only two for Tx), although performance might be degraded somewhat, and more UE averaging would be needed.

Operation 404 represents configuring CSI-RS and SRS (with antenna switching) reference signals on the same downlink and uplink frequency/radio resources (resource blocks) for those selected UEs. Based on the SRS data, block 406 represents, assuming no calibration error, calculating the PMI that maximizes the throughput (P_SRS) and compare it with that received from the UE in the CSI report (P_CSI). The operations continue at FIG. 5.

More particularly, for each antenna i (selected via operation 502, and thereafter via operations 514 and 516), operation 504 estimates the calibration coefficient for the iteration as a phase difference between the CSI-based PMI and SRS-based PMI estimate as shown in equations (3) and (4):

$${\hat{C}}_{i , n} = {e}^{j {α}_{i , n}} , \qquad ( 3 )$$

$${α}_{i , n} = angle ( {e}^{j ( {∅}_{{P\_CSI}_{i , n}} - {∅}_{{P\_SRS}_{i , n}} )} ) , \qquad ( 4 )$$

where angle(⋅) is the mathematical function that extracts the angle of a complex number, Ø_{P_CSI}_{_{i,n}} is the phase of antenna i requested by the UE/CSI report n, and Ø_{P_SRS}_{_{i,n}} is the phase of antenna i estimated based on SRS at the time of report n.

As previously described herein with reference to block 204, because the UE's CSI-based PMI (P_CSI_{i,n}) is often heavily quantized (up to ninety degrees in some cases) as defined by the 3GPP, the calibration of the base station phase can be inaccurate and suffer from the large quantization. However, when taking into account many P_CSI_{i,n} reports from many different UEs, and/or at different times, each typically coming from different directions and angles, as in Equation (2) (and described with reference to FIG. 3), the quantization error impact reduces or is smoothed by mathematically combining the P_CSI_{i,n} data, “e.g., averaging out” the information. For example, to reduce the PMI codebook quantization and estimation errors, example operation 506 mathematically combines (e.g., calculates the average value) over multiple reports as in equations (5) and (6):

$${\hat{C}}_{i} = {e}^{j {α}_{i}} , \qquad ( 5 )$$

$${α}_{i} = \frac{{\sum }_{n = 1}^{{N}_{CSI}} angle ( {e}^{j * ( {∅}_{{P\_CSI}_{i , n}} - {∅}_{{P\_SRS}_{i , n}} )} )}{{N}_{CSI}} \qquad ( 6 )$$

For muti-layer PMI, the same RI and phase relationship between layers, as the UE reports in its CSI-based PMI, can be used for the calculation of the SRS-based PMI.

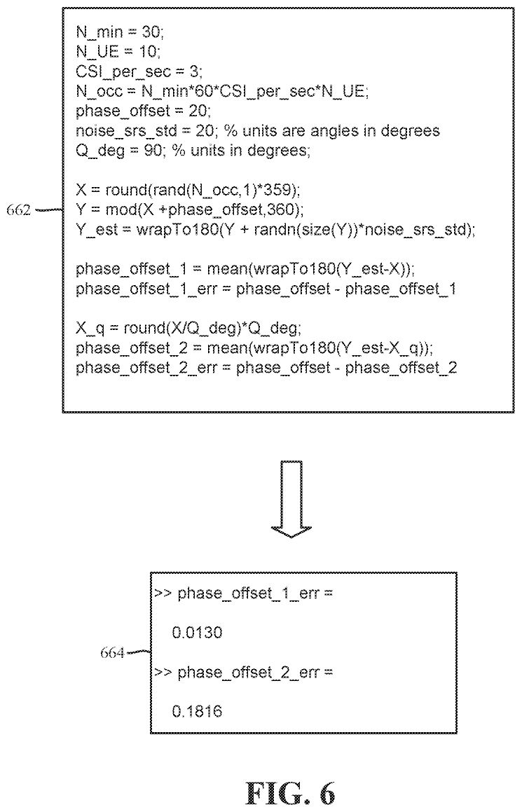

To illustrate that quantization has a minor impact on the estimated phase after combining different CSI reports, an example has been evaluated numerically as seen in the example code snippet 662 of FIG. 6. The sample output 664 of this example code 662 indicates low phase offset errors.

With respect to sub-bands, although not explicitly shown, the technology described herein can be expanded to have multiple calibration coefficients, that is, one for each frequency band. To achieve this, the UEs need to be configured to report sub-band PMI, and the optimization problem set forth in equation (2) needs to be solved for each sub-band independently.

After calculating the calibration phase at for each antenna i, the base station can apply different measures. Returning to FIG. 5, as shown in operation 508, the base station may apply the calibration phasor Cᵢ (coefficient) over the SRS-based precoding matrix to recalibrate the Tx-Rx phase for the selected antenna.

In the case that the phases were expected to be calibrated, that is, |αᵢ| is expected to be close to zero, a threshold value may be (optionally) used at optional operation 510 to determine whether an error has occurred by the checking the condition as set forth in (7):

$$If \vert {α}_{i} \vert > {α}_{max} , decide an error has occurred \qquad ( 7 )$$

If an error occurred, the base station can add the error data (e.g., antenna index i and the calibration phase error αᵢ to an error message (operation 512) to be sent (operation 518) to the high layers or the operator, e.g., resulting in a technician fixing the issue(s). Instead of operations 512 and 518, or in addition to operations 512 and 518, αᵢ can be collected and sent (e.g., periodically) to the higher layers/operator as raw data. In this way, the operator can decide the thresholds for sending a technician, without configuring the distributed unit with a set of threshold values. Further, the network operator may analyze the raw data standalone or in conjunction with other raw data (e.g., the radio unit's temperature) to detect useful correlations. For example, the phase difference may be found to be significant when the radio unit's temperature exceeds a certain threshold temperature.

It should be noted that FIGS. 4 and 5 only depict operations of one example procedure, and alternatives can be used. For example, at least some of the operations of FIG. 5 may be performed in parallel, rather than operating with respect to one antenna at a time as represented. Similarly, the order depicted is non-limiting, e.g., the calibration coefficient/phasor can be subject to the threshold error evaluation, e.g., operation 508 can only be performed if the error threshold is satisfied.

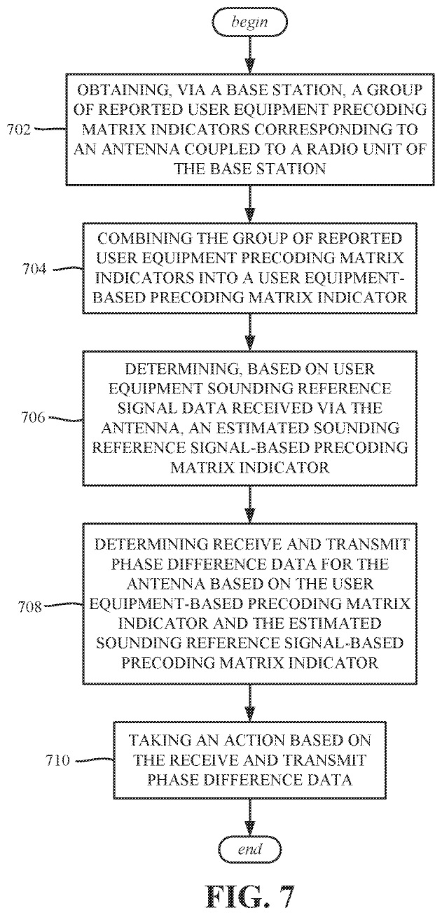

One or more implementations and embodiments can be embodied in network equipment, such as represented in the example operations of FIG. 7, and for example can include a memory that stores computer executable components and/or operations, and at least one processor that executes computer executable components and/or operations stored in the memory. Example operations can include operation 702, which represents obtaining, via a base station, a group of reported user equipment precoding matrix indicators corresponding to an antenna coupled to a radio unit of the base station. Example operation 704 represents combining the group of reported user equipment precoding matrix indicators into a user equipment-based precoding matrix indicator. Example operation 706 represents determining, based on user equipment sounding reference signal data received via the antenna, an estimated sounding reference signal-based precoding matrix indicator. Example operation 708 represents determining receive and transmit phase difference data for the antenna based on the user equipment-based precoding matrix indicator and the estimated sounding reference signal-based precoding matrix indicator. Example operation 710 represents taking an action based on the receive and transmit phase difference data.

Combining the reported user equipment precoding matrix indicators can include averaging the group of reported user equipment precoding matrix indicators to obtain the user equipment-based precoding matrix indicator.

The group of reported user equipment precoding matrix indicators can be obtained from a single user equipment device via different channel state information reports received by the base station within a timeframe.

The group of reported user equipment precoding matrix indicators can be obtained from at least two different user equipment devices via different channel state information reports received by the base station.

Determining the estimated sounding reference signal-based precoding matrix indicator can be based on a transmitter channel gain and a receiver channel gain.

Taking the action based on the receive and transmit phase difference data can include determining phase difference calibration coefficient data, and applying, via the base station, the phase difference coefficient calibration data to compensate for the receive and transmit phase difference data with respect to the antenna. Applying, via the base station, the phase difference coefficient calibration data to compensate for the receive and transmit phase difference data with respect to the antenna can include adjusting, by a distributed unit coupled to the radio unit, a relative phase of transmitted data and received data.

The receive and transmit phase difference data can correspond to error data, and the determining of the phase difference calibration coefficient data can include determining a phase difference calibration coefficient that minimizes the error data.

Taking the action based on the receive and transmit phase difference data can include determining whether the receive and transmit phase difference data satisfies a phase difference error threshold value, and, in response to the receive and transmit phase difference data satisfying the phase difference error threshold value, determining phase difference calibration data, and applying, via the base station, the phase difference calibration data to compensate for the receive and transmit phase difference data with respect to the antenna.

Taking the action based on the receive and transmit phase difference data can include determining whether the receive and transmit phase difference data satisfies a phase difference error, and, in response to the receive and transmit phase difference data satisfying the phase difference error, outputting data representative of the phase difference error to an operator associated with the base station.

The antenna can be a first antenna, the group of reported user equipment precoding matrix indicators can be a first group of reported user equipment precoding matrix indicators corresponding to the first antenna, the group of reported user equipment precoding matrix indicators can be a first group, the user equipment-based precoding matrix indicator can be a first user equipment-based precoding matrix indicator, the sounding reference signal data can be first sounding reference signal, the receive and transmit phase difference data can be first receive and transmit phase difference data, the action can be a first action, and further operations further can include obtaining, via the base station, a second group of reported user equipment precoding matrix indicators corresponding to a second antenna of the base station that is different from the first antenna, combining the second group of reported user equipment precoding matrix indicators into a second user equipment-based precoding matrix indicator, determining, based on second user equipment sounding reference signal data received via the second antenna, a second estimated sounding reference signal-based precoding matrix indicator, determining second receive and transmit phase difference data for the second antenna based on the second user equipment-based precoding matrix indicator and the second estimated sounding reference signal-based precoding matrix indicator, and taking a second action based on the second receive and transmit phase difference data.

The group of reported user equipment precoding matrix indicators can be a first group of reported user equipment precoding matrix indicators corresponding to a first frequency sub-band, the group of reported user equipment precoding matrix indicators can be a first group, the user equipment-based precoding matrix indicator can be a first user equipment-based precoding matrix indicator, the sounding reference signal data can be first sounding reference signal, the receive and transmit phase difference data can be first receive and transmit phase difference data, the action can be a first action, further operations can include obtaining, via the base station, a second group of reported user equipment precoding matrix indicators corresponding to a second frequency sub-band that is different from the first frequency sub-band, combining the second group of reported user equipment precoding matrix indicators into a second user equipment-based precoding matrix indicator, determining, based on second user equipment sounding reference signal data received in the second frequency sub-band, a second estimated sounding reference signal-based precoding matrix indicator, determining second receive and transmit phase difference data for the second frequency sub-band based on the second user equipment-based precoding matrix indicator and the second estimated sounding reference signal-based precoding matrix indicator, and taking a second action based on the second receive and transmit phase difference data.

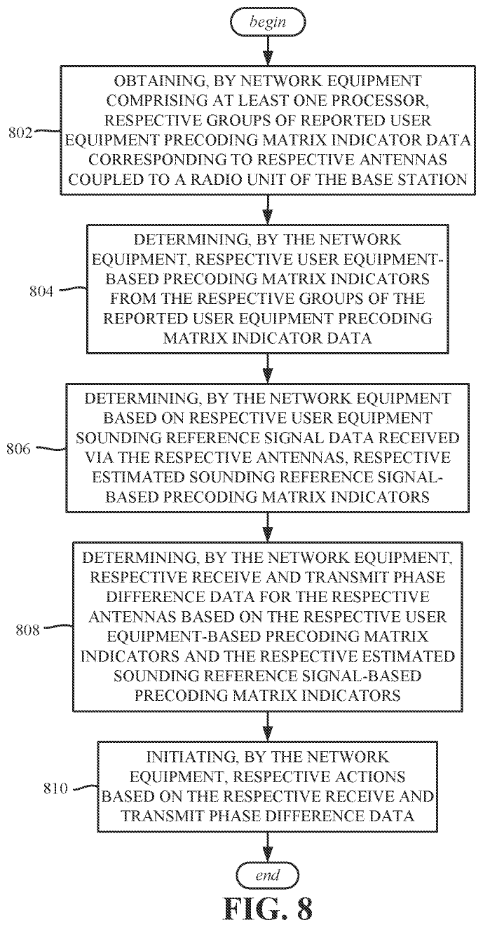

One or more example implementations and embodiments, such as corresponding to example operations of a method, are represented in FIG. 8. Example operation 802 represents obtaining, by network equipment comprising at least one processor, respective groups of reported user equipment precoding matrix indicator data corresponding to respective antennas coupled to a radio unit of the base station. Example operation 804 represents determining, by the network equipment, respective user equipment-based precoding matrix indicators from the respective groups of the reported user equipment precoding matrix indicator data. Example operation 806 represents determining, by the network equipment based on respective user equipment sounding reference signal data received via the respective antennas, respective estimated sounding reference signal-based precoding matrix indicators. Example operation 808 represents determining, by the network equipment, respective receive and transmit phase difference data for the respective antennas based on the respective user equipment-based precoding matrix indicators and the respective estimated sounding reference signal-based precoding matrix indicators. Example operation 810 represents initiating, by the network equipment, respective actions based on the respective receive and transmit phase difference data.

Determining the respective user equipment-based precoding matrix indicators from the respective groups of the reported user equipment precoding matrix indicator data can include averaging the respective user equipment-based precoding matrix indicator data to determine the respective user equipment-based precoding matrix indicators.

The respective actions can include determining respective phase difference calibration coefficients, and applying the respective phase difference calibration coefficients to recalibrate respective transmit-receive phase offsets with respect to the respective antennas.

The respective actions can include at least one of: reporting respective error data based on the respective receive and transmit phase difference data for the respective antennas, or reporting respective raw instances of the respective receive and transmit phase difference data for the respective antennas.

The respective actions can include, for each of the respective antennas, determining whether the respective receive and transmit phase difference data for the respective antenna satisfies a phase difference error threshold value, and, in response to the respective receive and transmit phase difference data satisfying the phase difference error threshold value, taking a respective corrective action with respect to the respective antenna.

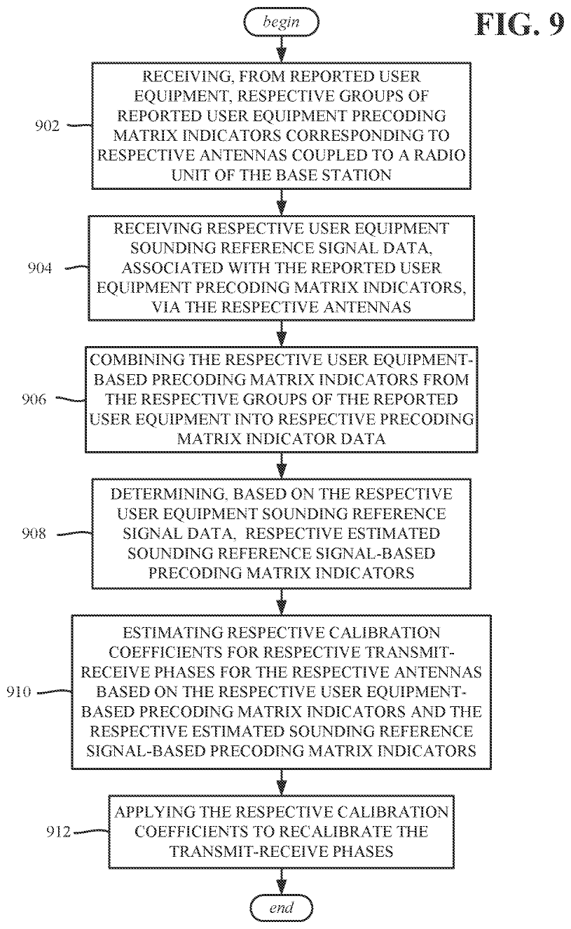

FIG. 9 summarizes various example operations, e.g., corresponding to a machine-readable medium, comprising executable instructions that, when executed by at least one processor of a base station, facilitate performance of operations. Example operation 902 represents receiving, from reported user equipment, respective groups of reported user equipment precoding matrix indicators corresponding to respective antennas coupled to a radio unit of the base station. Example operation 904 represents receiving respective user equipment sounding reference signal data, associated with the reported user equipment precoding matrix indicators, via the respective antennas. Example operation 906 represents combining the respective user equipment-based precoding matrix indicators from the respective groups of the reported user equipment into respective precoding matrix indicator data. Example operation 908 represents determining, based on the respective user equipment sounding reference signal data, respective estimated sounding reference signal-based precoding matrix indicators. Example operation 910 represents estimating respective calibration coefficients for respective transmit-receive phases for the respective antennas based on the respective user equipment-based precoding matrix indicators and the respective estimated sounding reference signal-based precoding matrix indicators. Example operation 912 represents applying the respective calibration coefficients to recalibrate the transmit-receive phases.

Further operations can include, prior to receiving the respective groups of reported user equipment precoding matrix indicators and receiving the respective user equipment sounding reference signal data, selecting respective user equipment for the group, and configuring respective channel state information reference signals and respective sounding reference signals on respective common resource blocks for the respective user equipment.

Determining the respective estimated sounding reference signal-based precoding matrix indicators can include determining respective sounding reference signal-based precoding matrix indicators that maximize respective throughput for the respective precoding matrix indicator data.

As can be seen, the technology described herein facilitates determining the phase difference between Tx-Rx pairs of an antenna. To accomplish this without additional signaling, the PMIs of a group of reported user equipment are averaged (or otherwise combined), which reduces the errors from quantization via the codebook, and an estimated SRS-based PMI is determined. The obtained phase difference based on the CSI-based PMI and the estimated SRS-based PMI can be used to notify high layers (up to the operator) and/or update the SRS-based precoding matrix to reflect and negate that miscalibration. Note that the technology described herein is particularly appropriate for time division duplexing (TDD) networks, where reciprocity is occurring over the same resource; however, it may be suitable for frequency division duplexing (FDD) networks in some use cases.

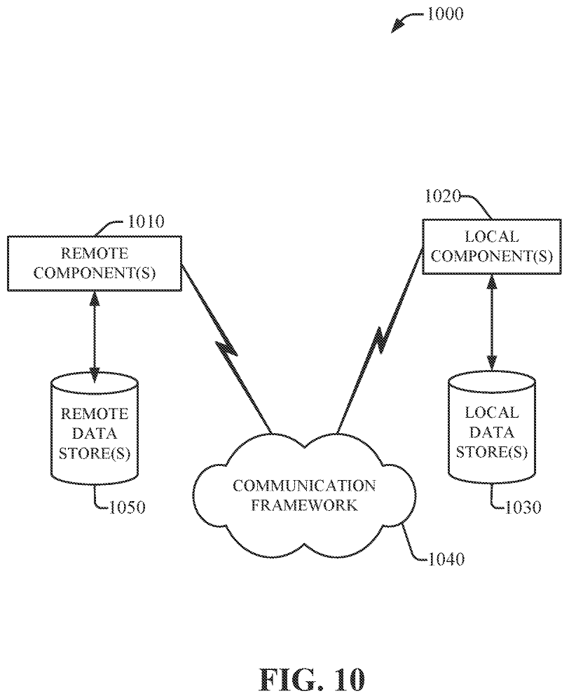

FIG. 10 is a schematic block diagram of a computing environment 1000 with which the disclosed subject matter can interact. The system 1000 can include one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

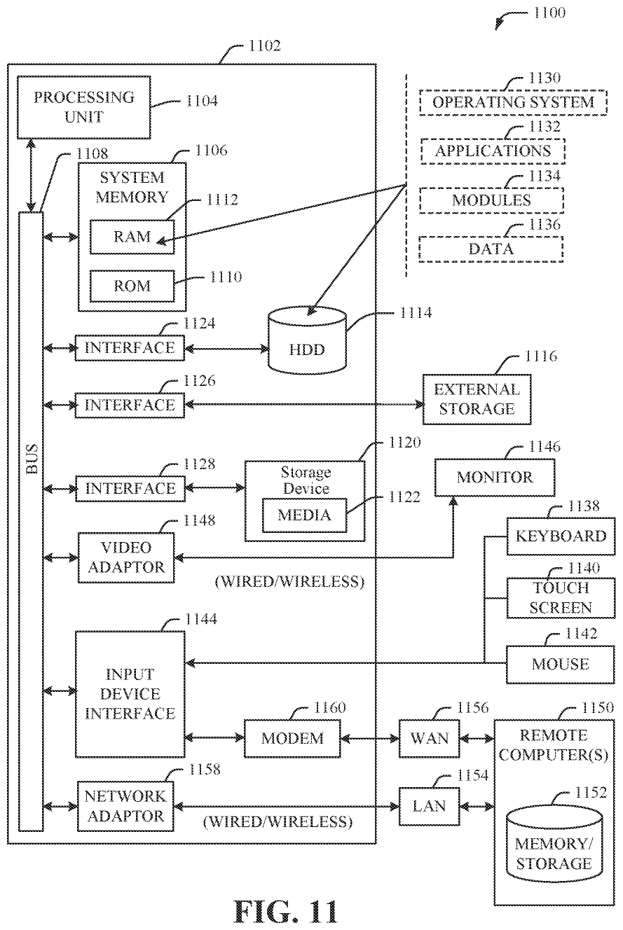

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various implementations and embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. Network equipment, comprising:
at least one processor; and
at least one memory that stores executable instructions that, when executed by the at least one processor, facilitate performance of operations, the operations comprising:
obtaining, via a base station, a group of reported user equipment precoding matrix indicators corresponding to an antenna coupled to a radio unit of the base station;
combining the group of reported user equipment precoding matrix indicators into a user equipment-based precoding matrix indicator;
determining, based on user equipment sounding reference signal data received via the antenna, an estimated sounding reference signal-based precoding matrix indicator;
determining receive and transmit phase difference data for the antenna based on the user equipment-based precoding matrix indicator and the estimated sounding reference signal-based precoding matrix indicator; and
taking an action based on the receive and transmit phase difference data.

2. The network equipment of claim 1, wherein the combining of the reported user equipment precoding matrix indicators comprises averaging the group of reported user equipment precoding matrix indicators to obtain the user equipment-based precoding matrix indicator.

3. The network equipment of claim 1, wherein the group of reported user equipment precoding matrix indicators is obtained from a single user equipment device via different channel state information reports received by the base station within a timeframe.

4. The network equipment of claim 1, wherein the group of reported user equipment precoding matrix indicators is obtained from at least two different user equipment devices via different channel state information reports received by the base station.

5. The network equipment of claim 1, wherein the determining of the estimated sounding reference signal-based precoding matrix indicator is based on a transmitter channel gain and a receiver channel gain.

6. The network equipment of claim 1, wherein the taking of the action based on the receive and transmit phase difference data comprises determining phase difference calibration coefficient data, and applying, via the base station, the phase difference coefficient calibration data to compensate for the receive and transmit phase difference data with respect to the antenna.

7. The network equipment of claim 6, wherein the applying, via the base station, the phase difference coefficient calibration data to compensate for the receive and transmit phase difference data with respect to the antenna comprises adjusting, by a distributed unit coupled to the radio unit, a relative phase of transmitted data and received data.

8. The network equipment of claim 6, wherein the receive and transmit phase difference data corresponds to error data, and wherein the determining of the phase difference calibration coefficient data comprises determining a phase difference calibration coefficient that minimizes the error data.

9. The network equipment of claim 1, wherein the taking of the action based on the receive and transmit phase difference data comprises determining whether the receive and transmit phase difference data satisfies a phase difference error threshold value, and, in response to the receive and transmit phase difference data satisfying the phase difference error threshold value, determining phase difference calibration data, and applying, via the base station, the phase difference calibration data to compensate for the receive and transmit phase difference data with respect to the antenna.

10. The network equipment of claim 1, wherein the taking of the action based on the receive and transmit phase difference data comprises determining whether the receive and transmit phase difference data satisfies a phase difference error, and, in response to the receive and transmit phase difference data satisfying the phase difference error, outputting data representative of the phase difference error to an operator associated with the base station.

11. The network equipment of claim 1, wherein the antenna is a first antenna, wherein the group of reported user equipment precoding matrix indicators is a first group of reported user equipment precoding matrix indicators corresponding to the first antenna, wherein the group of reported user equipment precoding matrix indicators is a first group, wherein the user equipment-based precoding matrix indicator is a first user equipment-based precoding matrix indicator, wherein the sounding reference signal data is first sounding reference signal, wherein the receive and transmit phase difference data is first receive and transmit phase difference data, wherein the action is a first action, wherein the operations further comprise:
obtaining, via the base station, a second group of reported user equipment precoding matrix indicators corresponding to a second antenna of the base station that is different from the first antenna;
combining the second group of reported user equipment precoding matrix indicators into a second user equipment-based precoding matrix indicator;
determining, based on second user equipment sounding reference signal data received via the second antenna, a second estimated sounding reference signal-based precoding matrix indicator;
determining second receive and transmit phase difference data for the second antenna based on the second user equipment-based precoding matrix indicator and the second estimated sounding reference signal-based precoding matrix indicator; and
taking a second action based on the second receive and transmit phase difference data.

12. The network equipment of claim 1, wherein the group of reported user equipment precoding matrix indicators is a first group of reported user equipment precoding matrix indicators corresponding to a first frequency sub-band, wherein the group of reported user equipment precoding matrix indicators is a first group, wherein the user equipment-based precoding matrix indicator is a first user equipment-based precoding matrix indicator, wherein the sounding reference signal data is first sounding reference signal, wherein the receive and transmit phase difference data is first receive and transmit phase difference data, wherein the action is a first action, wherein the operations further comprise:
obtaining, via the base station, a second group of reported user equipment precoding matrix indicators corresponding to a second frequency sub-band that is different from the first frequency sub-band;
combining the second group of reported user equipment precoding matrix indicators into a second user equipment-based precoding matrix indicator;
determining, based on second user equipment sounding reference signal data received in the second frequency sub-band, a second estimated sounding reference signal-based precoding matrix indicator;
determining second receive and transmit phase difference data for the second frequency sub-band based on the second user equipment-based precoding matrix indicator and the second estimated sounding reference signal-based precoding matrix indicator; and
taking a second action based on the second receive and transmit phase difference data.

13. A method, comprising:
obtaining, by network equipment comprising at least one processor, respective groups of reported user equipment precoding matrix indicator data corresponding to respective antennas coupled to a radio unit of the base station;
determining, by the network equipment, respective user equipment-based precoding matrix indicators from the respective groups of the reported user equipment precoding matrix indicator data;
determining, by the network equipment based on respective user equipment sounding reference signal data received via the respective antennas, respective estimated sounding reference signal-based precoding matrix indicators;
determining, by the network equipment, respective receive and transmit phase difference data for the respective antennas based on the respective user equipment-based precoding matrix indicators and the respective estimated sounding reference signal-based precoding matrix indicators; and
initiating, by the network equipment, respective actions based on the respective receive and transmit phase difference data.

14. The method of claim 13, wherein the determining of the respective user equipment-based precoding matrix indicators from the respective groups of the reported user equipment precoding matrix indicator data comprises averaging the respective user equipment-based precoding matrix indicator data to determine the respective user equipment-based precoding matrix indicators.

15. The method of claim 13, wherein the respective actions comprise determining respective phase difference calibration coefficients, and applying the respective phase difference calibration coefficients to recalibrate respective transmit-receive phase offsets with respect to the respective antennas.

16. The method of claim 13, wherein the respective actions comprise at least one of: reporting respective error data based on the respective receive and transmit phase difference data for the respective antennas, or reporting respective raw instances of the respective receive and transmit phase difference data for the respective antennas.

17. The method of claim 13, wherein the respective actions comprise, for each of the respective antennas, determining whether the respective receive and transmit phase difference data for the respective antenna satisfies a phase difference error threshold value, and, in response to the respective receive and transmit phase difference data satisfying the phase difference error threshold value, taking a respective corrective action with respect to the respective antenna.

18. A non-transitory machine-readable medium, comprising executable instructions that, when executed by at least one processor of a base station, facilitate performance of operations, the operations comprising:
receiving, from reported user equipment, respective groups of reported user equipment precoding matrix indicators corresponding to respective antennas coupled to a radio unit of the base station;
receiving respective user equipment sounding reference signal data, associated with the reported user equipment precoding matrix indicators, via the respective antennas;
combining the respective user equipment-based precoding matrix indicators from the respective groups of the reported user equipment into respective precoding matrix indicator data;
determining, based on the respective user equipment sounding reference signal data, respective estimated sounding reference signal-based precoding matrix indicators;
estimating respective calibration coefficients for respective transmit-receive phases for the respective antennas based on the respective user equipment-based precoding matrix indicators and the respective estimated sounding reference signal-based precoding matrix indicators; and
applying the respective calibration coefficients to recalibrate the transmit-receive phases.

19. The non-transitory machine-readable medium of claim 18, wherein the operations further comprise, prior to receiving the respective groups of reported user equipment precoding matrix indicators and receiving the respective user equipment sounding reference signal data, selecting respective user equipment for the group, and configuring respective channel state information reference signals and respective sounding reference signals on respective common resource blocks for the respective user equipment.

20. The non-transitory machine-readable medium of claim 18, wherein the determining of the respective estimated sounding reference signal-based precoding matrix indicators comprises determining respective sounding reference signal-based precoding matrix indicators that maximize respective throughput for the respective precoding matrix indicator data.
